(19) United States
(12) Patent Application Publication
(10) Pub. No.: US 2026/0167032 A1
(43) Pub. Date: Jun. 18, 2026

(54) CHARGING DEVICE

(71) Applicant: LG ELECTRONICS INC., Seoul (KR)

(72) Inventors: Suk KO, Seoul (KR); Cheolhong PARK, Seoul (KR); Sunghwan OH, Seoul (KR); Myoungku LEE, Seoul (KR); Hyoseon KIM, Seoul (KR)

(73) Assignee: LG ELECTRONICS INC., Seoul (KR)

(21) Appl. No.: 19/186,231

(22) Filed: Apr. 22, 2025

(30) Foreign Application Priority Data
Dec. 18, 2024 (KR) 10-2024-0189646

(51) Int. Cl. B60L 53/31; B60L 53/302; H02B 1/32; H02B 1/56

(52) U.S. Cl. CPC B60L 53/31; B60L 53/302; H02B 1/32; H02B 1/565

(57) ABSTRACT

Disclosed is a charging device including a casing where a power module is mounted and an accommodation space where an input module and an output module electrically connected to the power module are located is defined, a shelf member partitioning the accommodation space of the casing in a vertical direction, and a seating bracket coupled to an upper surface of the shelf member, wherein the power module is seated on the seating bracket, wherein the seating bracket includes an inclined surface inclined from one end to an opposite end. The power module is seated in an inclined state on the inclined surface. The charging device removes moisture caused by dew condensation of the power module to improve electrical stability.

### CROSS REFERENCE TO RELATED APPLICATION

Pursuant to 35 U.S.C. § 119(a), this application claims the benefit of earlier filing date and right of priority to Korean Patent Application No. 10-2024-0189646, filed on Dec. 18, 2024, the contents of which are hereby incorporated by reference herein in its entirety.

### BACKGROUND

### Field

The present disclosure relates to a charging device for charging an electric vehicle that may remove moisture caused by dew condensation of a power module.

### Discussion of the Related Art

In general, an electric vehicle (EV) has not been put into practical use for a long time because of problems such as a great weight of a battery mounted in the vehicle and a time it takes to charge when compared to a gasoline or diesel vehicle. However, recently, because of a depletion of fossil energy and environmental pollution, interest in the electric vehicle that does not use the fossil energy but uses electric energy has increased, and research and development on the electric vehicle have been actively conducted.

As a result, popularization of the electric vehicle has been increasing recently. The electric vehicle has a battery that supplies power for operation thereof, and has a structure in which the power is stored in the battery. Therefore, to continuously operate the electric vehicle, the battery must be charged. Accordingly, an infrastructure for charging the electric vehicle is needed, and fixed standing charging facilities are being established in various locations to meet an increasing demand for the electric vehicle.

Charging facilities for the electric vehicle include a split charging facility and an integrated charging facility. The split charging facility includes a power cabinet in which multiple electronic components including a power module are mounted in a box-shaped casing, and a dispenser that receives power from the power cabinet and charges the electric vehicle. In the integrated charging facility, the above-described dispenser and power cabinet constitute a single body and are integrally formed to charge the electric vehicle.

In this regard, it is required to secure a space for installing the charging facility for the electric vehicle. To this end, there is a need for a structural means capable of reducing a size of the casing in which the multiple electronic components are mounted. For example, a method of efficiently utilizing an accommodation space in which the electronic components are mounted by changing an arrangement structure of the electronic components mounted in the casing may be considered.

In particular, in a case of a power module that performs power conversion of received AC power into DC power, which is charging power for charging the electric vehicle, heat is generated from internal components of the power module during the power conversion process. In this regard, dew condensation occurs inside the power module because of a temperature difference between outside air and inside air.

In this case, an abnormal operation may occur while moisture caused by the dew condensation of the power module accumulates in the power module, and thus, a failure may occur in the charging facility of the electric vehicle requiring electrical stability.

Therefore, to stably operate the charging facility of the electric vehicle, there is a need for a method for removing the moisture caused by the dew condensation of the power module.

### SUMMARY

The present disclosure relates to a charging device, and more particularly, is to provide a charging device that may improve electrical stability by removing moisture caused by dew condensation of a power module.

In addition, the present disclosure is to provide a charging device that may efficiently reduce heat generation by operation of a power module via arrangement of an opening hole defined in a casing and a blower.

In addition, the present disclosure is to provide a charging device that may efficiently arrange multiple electronic components via a shelf member and an inner plate that partition an accommodation space.

The problems to be solved by the present disclosure are not limited to the above-mentioned technical problems, and other technical problems not mentioned will be clearly understood by those skilled in the art to which the present disclosure pertains from the following description.

Provided is a charging device including a casing where a power module is mounted and an accommodation space where an input module and an output module electrically connected to the power module are located is defined, a shelf member partitioning the accommodation space of the casing in a vertical direction, and a seating bracket coupled to an upper surface of the shelf member, wherein the power module is seated on the seating bracket, wherein the seating bracket includes an inclined surface inclined from one end to an opposite end, wherein the power module is seated in an inclined state on the inclined surface.

The seating bracket may have the inclined surface forming a step with the upper surface of the shelf member.

The charging device may further include a filter member disposed in the accommodation space to face the one end of the inclined surface, the power module, and the shelf member.

The filter member may be disposed in the vertical direction and have a lower surface located downward of a lower surface of the shelf member.

The charging device may further include a blower disposed in the accommodation space to face the opposite end of the inclined surface and the power module.

The blower may be formed to exhaust air toward the power module or to inhale air from the power module.

The casing may include a plurality of first opening holes defined at locations corresponding to the filter member, and a plurality of second opening holes defined at locations corresponding to the blower.

The power module may include a plurality of power modules seated upright on the inclined surface.

The inclined surface may include a plurality of seating ribs formed to be spaced apart from each other and extending from the one end to the opposite end.

The charging device may further include a fixing bracket disposed in the accommodation space and fixing the plurality of power modules seated on the seating bracket.

The fixing bracket may have a fixing surface inclined from one end to an opposite end corresponding to the inclined surface.

The upper surface of the shelf member may be coated.

The charging device may further include a printed circuit board disposed inside the shelf member and having electronic components mounted on a front surface thereof, and the shelf member may include a coupling surface formed therein and coupled to a rear surface of the printed circuit board such that a front surface of the printed circuit board faces downward.

The coupling surface may be inclined from one end to the other end corresponding to the inclined surface.

The rear surface of the printed circuit board may be coated and coupled to the coupling surface.

The casing may be formed in a shape with open front and rear sides, and the inclined surface may be inclined in a rearward direction.

The charging device may further include an inner plate disposed to be upright on a lower surface of the shelf member and partitioning the accommodation space in a front and rear direction.

The input module may be disposed on a front surface of the inner plate, and the output module may be disposed on a rear surface of the inner plate.

The charging device may further include a dispenser that receives power converted via the power module and performs charging.

The dispenser may include a plurality of dispensers that receive the power via a plurality of power cables connected to the output module.

The charging device according to the present disclosure may improve the electrical stability by removing the moisture caused by the dew condensation of the power module.

In addition, the heat generation by the operation of the power module may be efficiently reduced via the arrangement of the opening hole defined in the casing and the blower.

In addition, the multiple electronic components may be efficiently arranged via the shelf member and the inner plate that partition the accommodation space.

The effects obtainable in the present disclosure are not limited to the above-mentioned effects, and other effects not mentioned will be clearly understood by those skilled in the art to which the present disclosure pertains from the following description.

### BRIEF DESCRIPTION OF THE DRAWINGS

FIG. 1 is a view illustrating a charging device according to an embodiment of the present disclosure.

FIG. 2 is a view illustrating a casing equipped with a shelf member partitioning an accommodation space in a vertical direction in a charging device according to an embodiment of the present disclosure.

FIG. 3 is a view illustrating a seating bracket in a charging device according to an embodiment of the present disclosure.

FIG. 4 is a front view of a seating bracket on which a power module is seated in a charging device according to an embodiment of the present disclosure.

FIG. 5 is a view illustrating a filter member coupled to a front door in a charging device according to an embodiment of the present disclosure.

FIG. 6 is a view illustrating a first moisture inflow prevention member and a filter member in a charging device according to an embodiment of the present disclosure.

FIG. 7 is a view illustrating inside of a power cabinet in a charging device according to an embodiment of the present disclosure.

FIG. 8 is an enlarged view of an area A in FIG. 7.

FIG. 9 is a view illustrating a blower coupled to a rear door in a charging device according to an embodiment of the present disclosure.

FIGS. 10 and 11 are views for illustrating a feature of removing moisture generated by operation of a power module in a charging device according to an embodiment of the present disclosure.

FIG. 12 is a view illustrating a shape in which a printed circuit board is coupled to a coupling surface formed on a shelf member in a charging device according to an embodiment of the present disclosure.

### DESCRIPTION OF SPECIFIC EMBODIMENTS

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

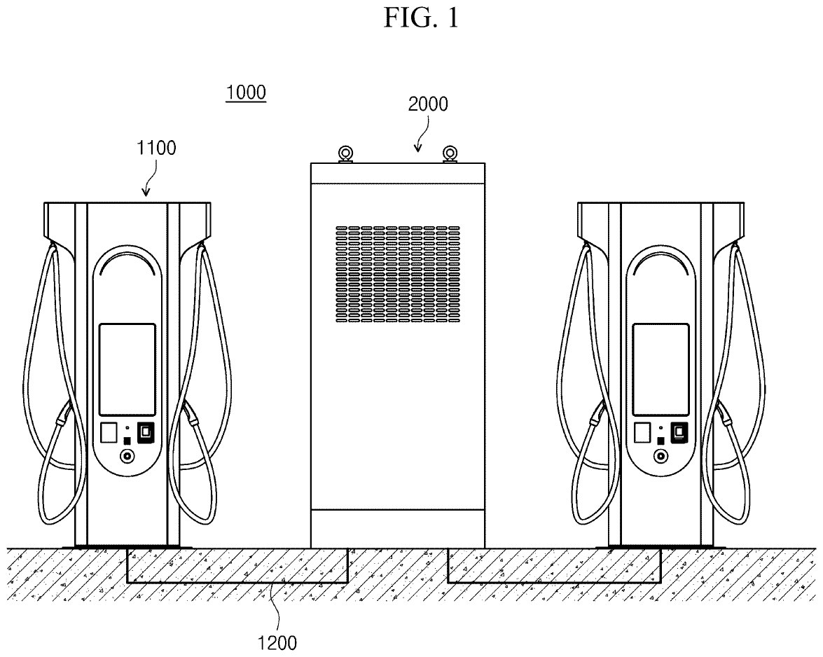

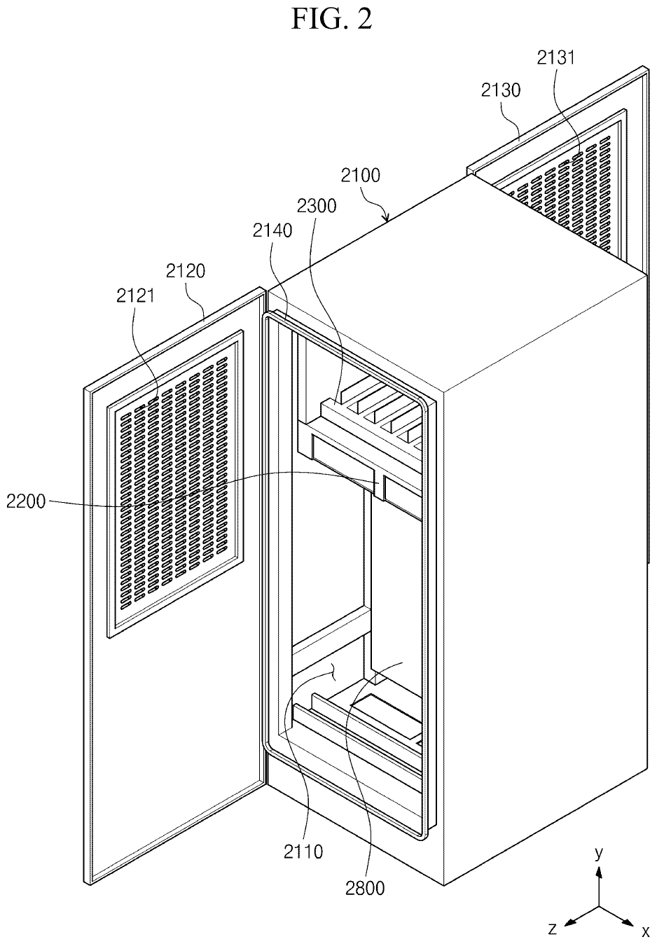

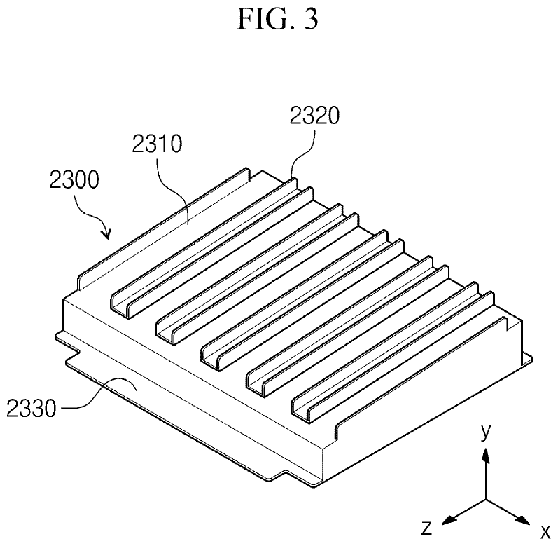

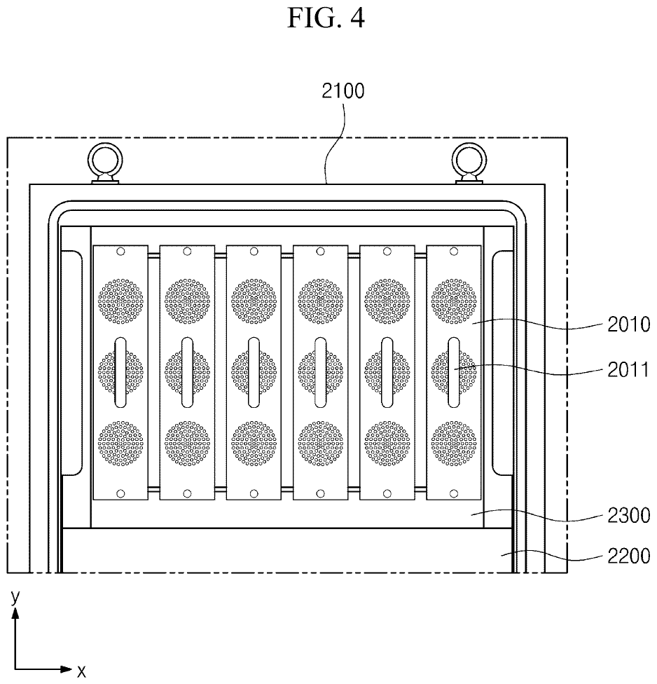

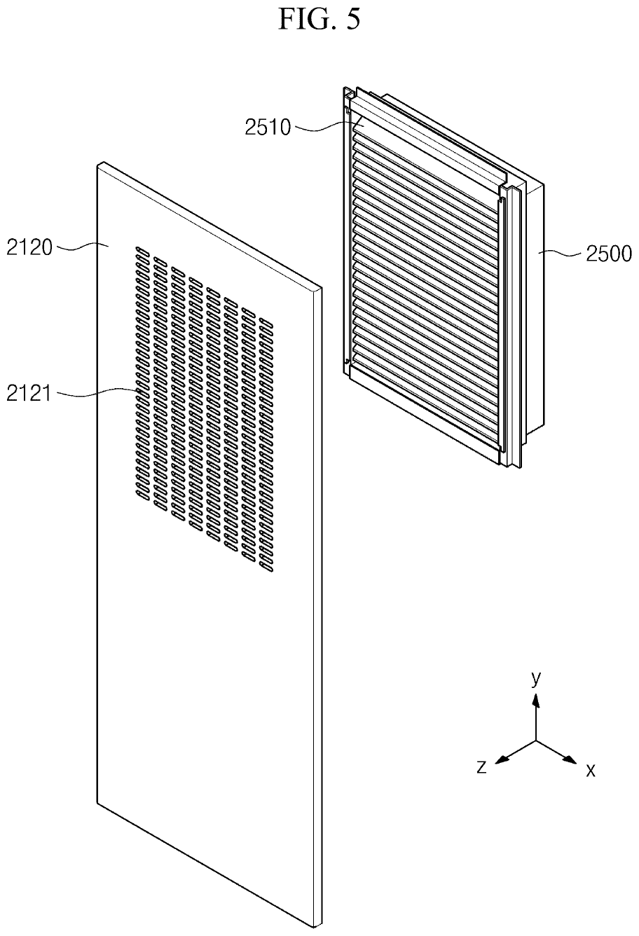

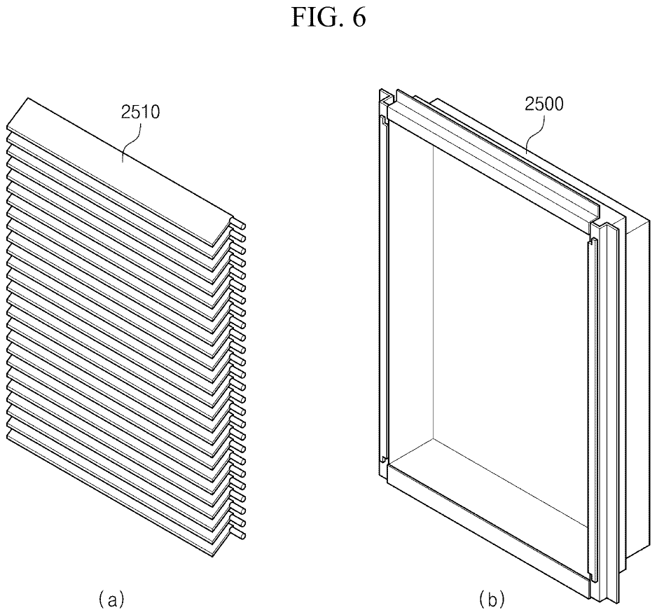

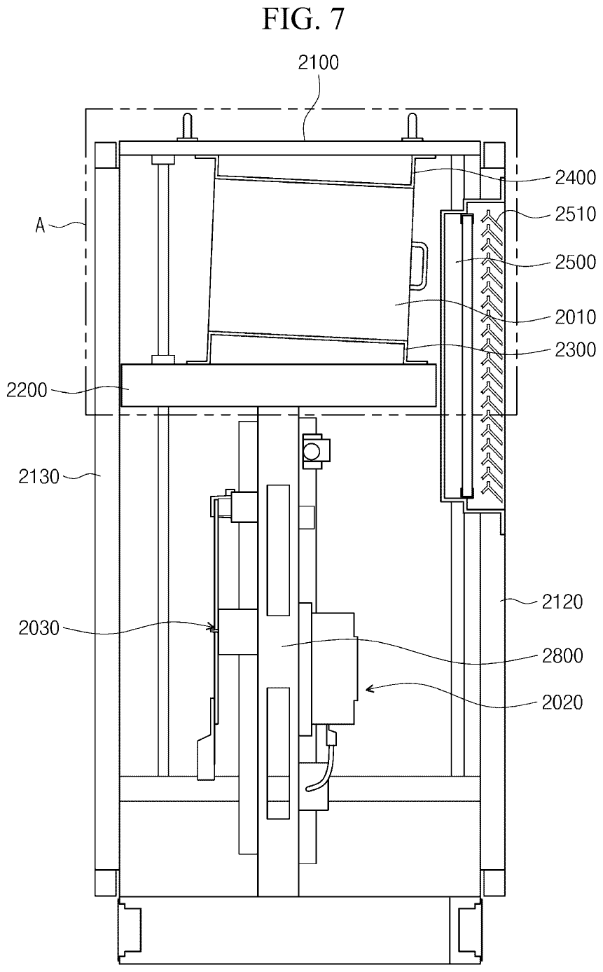

FIG. 1 is a view illustrating a charging device 1000 according to an embodiment of the present disclosure. FIG. 2 is a view illustrating a casing 2100 equipped with a shelf member 2200 partitioning an accommodation space 2110 in a vertical direction (a y-axis direction) in the charging device 1000 according to an embodiment of the present disclosure. FIG. 3 is a view illustrating a seating bracket 2300 in the charging device 1000 according to an embodiment of the present disclosure. FIG. 4 is a front view of the seating bracket 2300 on which a power module 2010 is seated in the charging device 1000 according to an embodiment of the present disclosure. FIG. 5 is a view illustrating a filter member 2500 coupled to a front door 2120 in the charging device 1000 according to an embodiment of the present disclosure. FIG. 6 is a view illustrating a first moisture inflow prevention member 2510 and the filter member 2500 in the charging device 1000 according to an embodiment of the present disclosure. Further, FIG. 7 is a view illustrating inside of a power cabinet 2000 in the charging device 1000 according to an embodiment of the present disclosure.

Hereinafter, in describing the charging device 1000 according to an embodiment of the present disclosure, a left and right direction will be referred to as an x-axis direction, a vertical direction as a y-axis direction, and a front and rear direction as a z-axis direction.

As described above, charging facilities of an electric vehicle may be categorized into a split charging facility and an integrated charging facility. The split charging facility may include a power cabinet in which multiple electronic components including a power module are mounted in a box-shaped casing, and a dispenser that receives power from the power cabinet and charges the electric vehicle. In the integrated charging facility, the above-described dispenser and power cabinet may constitute a single body and be integrally formed to perform charging of the electric vehicle.

Further, the charging device 1000 of the present disclosure may have a structure applicable to both the above-described split charging facility and integrated charging facility.

In addition, the charging device 1000 of the present disclosure may correspond to the power cabinet in the above-described split charging facility. In addition, the charging device 1000 of the present disclosure may correspond to the dispenser in the above-described split charging facility. That is, the charging device 1000 of the present disclosure to be described later may have a structure applicable to both the power cabinet and the dispenser in the split charging facility.

In particular, the charging device 1000 of the present disclosure may remove moisture caused by dew condensation of the power module via an accommodation space and a placement form of the power module serving to convert received power into charging power for charging the electric vehicle in the split charging facility and the integrated charging facility. More details thereof will be described later.

FIG. 1 is a view illustrating the split charging facility among the charging facilities described above. As illustrated in FIG. 1, the charging device 1000 according to an embodiment of the present disclosure may include the dispenser 1100 that receives the power and charges the electric vehicle (EV), and the power cabinet 2000 that supplies the power to the dispenser 1100. Further, the dispenser 1100 may receive the power via a power cable 1200 connected to the power cabinet 2000. In this regard, a plurality of dispensers 1100 may be disposed as illustrated in FIG. 1, and the power cabinet 2000 may supply the power to the plurality of dispensers 1100 via the power cable 1200.

Referring to FIGS. 2 to 7 together, the charging device 1000 according to an embodiment of the present disclosure may include the casing 2100 in which the power module 2010 is mounted and the accommodation space 2110 where an input module 2020 and an output module 2030 electrically connected to the power module 2010 are located is defined.

In this regard, the casing 2100 may be formed in a shape in which front and rear sides are open. In addition, the casing 2100 may include a front door 2120 coupled to be opened and closed from the front and a rear door 2130 coupled to be opened and closed from the rear. In this case, the casing 2100 may include a sealing member 2140 coupled along peripheries of the front surface and the rear surface.

In addition, the front door 2120 and the rear door 2130 are coupled to the casing 2100 via the sealing member 2140 and block a gap that may occur, thereby securing electrical stability or the like via a waterproof structure.

In addition, the charging device 1000 according to an embodiment of the present disclosure may include the shelf member 2200 that partitions the accommodation space 2110 of the casing 2100 in a vertical direction (a y-axis direction). In this regard, the seating bracket 2300 may be coupled to an upper surface 2210 of the shelf member 2200. In addition, the seating bracket 2300 may be formed such that the power module 2010 is seated thereon.

In particular, in the charging device 1000 according to an embodiment of the present disclosure, the seating bracket 2300 may include an inclined surface 2310 inclined from one end to the other end, as shown in FIGS. 3 and 7. In addition, the power module 2010 may be seated on the inclined surface 2310 of the seating bracket 2300 in an inclined state. In addition, the seating bracket 2300 may have a seating surface 2330 at a lower portion thereof, and may be coupled to the upper surface 2210 of the shelf member 2200 via the seating surface 2330.

As described above, in a case of the power module that performs power conversion of AC power received from an input module 2020 into DC power, which is charging power to be supplied to the dispenser 1100, heat is generated from internal components of the power module 2010 during the power conversion process. In this regard, dew condensation occurs inside the power module 2010 because of a temperature difference between outside air and inside air.

In this case, an abnormal operation may occur while moisture caused by the dew condensation of the power module 2010 accumulates in the power module 2010, and thus, a failure may occur in the charging facility 1000 requiring electrical stability.

Therefore, to stably operate the charging facility requiring the electrical stability, there is a need for a method for removing the moisture caused by the dew condensation of the power module 2010.

To this end, as illustrated in FIGS. 3 and 7, in the charging device 1000 according to an embodiment of the present disclosure, the seating bracket 2300 may be formed such that the inclined surface 2310 and the upper surface 2210 of the shelf member 2200 form a step. In this regard, the upper surface 2210 of the shelf member 2200 may be coated.

As will be described below, the charging device 1000 according to an embodiment of the present disclosure may be seated in an inclined state on the inclined surface 2310 of the seating bracket 2300, and the moisture caused by the dew condensation of the power module 2010 may be dropped to the upper surface 2210 of the shelf member 2200 forming the step with the inclined surface 2310. In addition, because the upper surface 2210 of the shelf member 2200 is coated, the moisture may remain on the upper surface 2210 of the shelf member 2200 or be introduced into the filter member 2500 facing the shelf member 2200.

That is, in the charging device 1000 according to an embodiment of the present disclosure, the above-described moisture removal may be achieved by forming a flow channel through which the moisture caused by the dew condensation of the power module 2010 flows via the inclined surface 2310 of the seating bracket 2300 formed to form the step with the upper surface 2210 of the shelf member 2200. More details thereof will be described later.

Additionally, in the charging device 1000 according to an embodiment of the present disclosure, the casing 2100 may be formed in the shape in which the front and rear sides are opened as described above. Accordingly, the inclined surface 2310 of the seating bracket 2300 may be inclined in a front and rear direction (a z-axis direction).

In addition, a case in which, in the charging device 1000 according to an embodiment of the present disclosure, one end of the inclined surface 2310 of the seating bracket 2300 located at a front side has a lower vertical level and the other end of the inclined surface 2310 located at a rear side has a higher vertical level is illustrated, but the present disclosure is not limited thereto.

That is, in the charging device 1000 according to an embodiment of the present disclosure, the seating bracket 2300 may be applied even assuming one end of the inclined surface 2310 located at the front side has a higher vertical level and the other end of the inclined surface 2310 located at the rear side has a lower vertical level.

Referring to FIGS. 3, 4, and 7 together, in the charging device 1000 according to an embodiment of the present disclosure, a plurality of power modules 2010 may be seated upright on the inclined surface 2310 of the seating bracket 2300. That is, the plurality of power modules 2010 may be seated in an inclined state on the inclined surface 2310 of the seating bracket 2300.

In this case, each of the plurality of power modules 2010 may have a handle 2011, and an operator may hold the handle 2011 and seat the power module 2010 on the inclined surface 2310 of the seating bracket 2300. To ensure ease of work of the operator, the inclined surface 2310 of the seating bracket 2300 may include a plurality of seating ribs 2320 formed to be spaced apart from each other and extending from one end to the other end.

In addition, the charging device 1000 according to an embodiment of the present disclosure may include a fixing bracket 2400 disposed in the accommodation space 2110 and for fixing the plurality of power modules 2010 seated on the seating bracket 2300. That is, the fixing bracket 2400 may be located above (in the y-axis direction of) the seating bracket 2300.

In this regard, the fixing bracket 2400 may have a fixing surface 2410 inclined from one end to the other end corresponding to the inclined surface 2310 of the seating bracket 2300. Accordingly, the operator may stably seat the power module 2010 on the seating bracket 2300 via the inclined surface 2310 of the seating bracket 2300 and the fixing surface 2410 of the fixing bracket 2400.

Additionally, although not shown in the drawings, a fixing rib having a shape corresponding to that of the seating rib 2320 formed on the inclined surface 2310 of the seating bracket 2300 described above may be formed on the fixing surface 2410 of the fixing bracket 2400. As described above, this may also serve to assist the operator in stably seating the power module 2010 on the seating bracket 2300.

Further, referring to FIGS. 5 to 7 together, the charging device 1000 according to an embodiment of the present disclosure may include the filter member 2500 disposed in the accommodation space 2110 to face one end of the inclined surface 2310, the power module 2010, and the shelf member 2200. In addition, the filter member 2500 may be coupled to the front door 2120 that is coupled to be opened and closed from the front of the casing 2100 described above. In this regard, a plurality of first opening holes 2121 may be defined in the front door 2120 at locations corresponding to the filter member 2500.

Additionally, the filter member 2500 may be coupled to the first moisture inflow prevention member 2510 illustrated in (a) in FIG. 6. The first moisture inflow prevention member 2510 may serve to block the moisture that may be introduced from the outside via the plurality of first opening holes 2121. Accordingly, the first moisture inflow prevention member 2510 may be in a form of an assembly of multiple plates forming an inclination in a downward direction (the y-axis direction) to block the moisture that may be introduced from the outside.

Hereinafter, a feature of removing the moisture caused by the dew condensation of the power module 2010 in the charging device 1000 according to an embodiment of the present disclosure will be described in more detail.

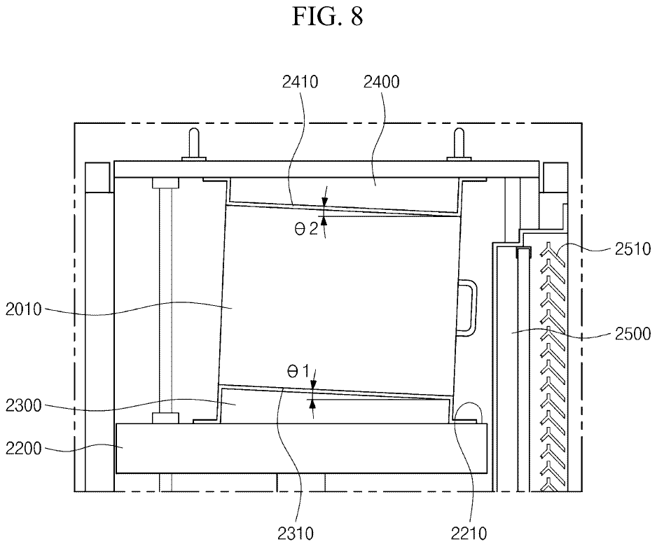

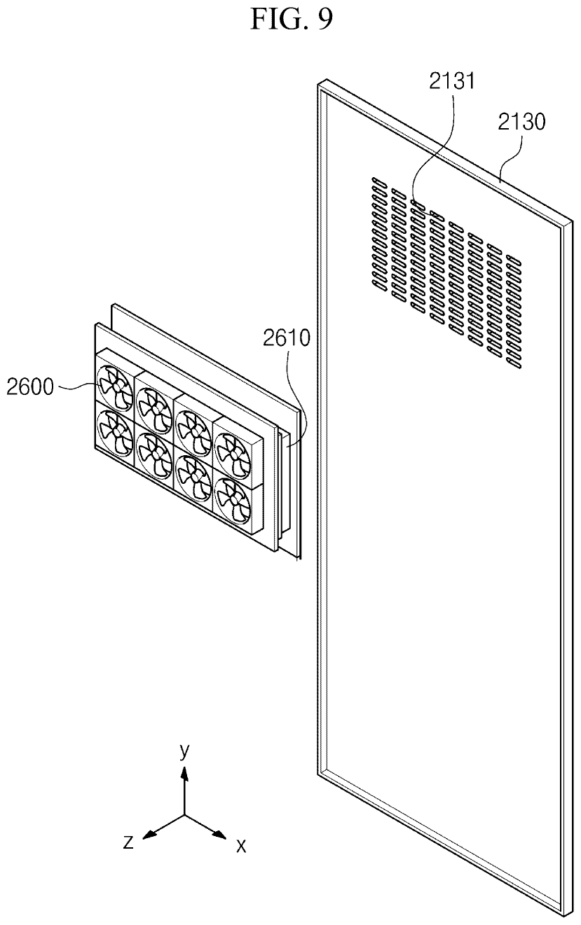

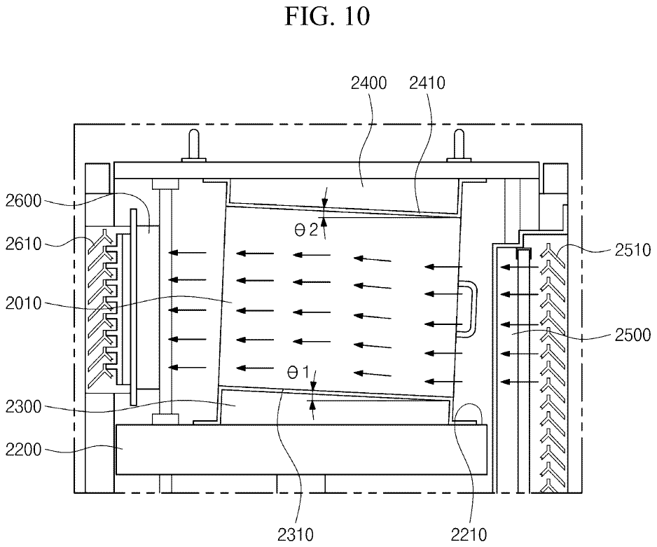

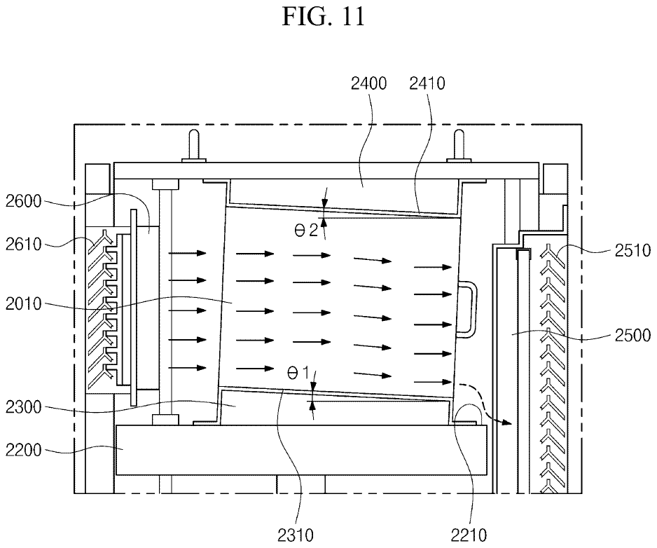

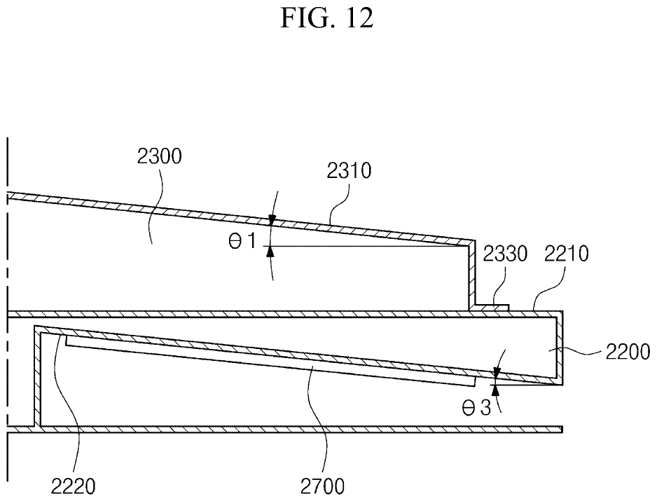

FIG. 8 is an enlarged view of an area A in FIG. 7. FIG. 9 is a view illustrating a blower 2600 coupled to the rear door 2130 in the charging device 1000 according to an embodiment of the present disclosure. FIGS. 10 and 11 are views for illustrating the feature of removing the moisture generated by operation of the power module 2010 in the charging device 1000 according to an embodiment of the present disclosure. In addition, FIG. 12 is a view illustrating a shape in which a printed circuit board 2700 is coupled to a coupling surface 2220 formed on the shelf member 2200 in the charging device 1000 according to an embodiment of the present disclosure.

As described above with reference to FIG. 7, the charging device 1000 according to an embodiment of the present disclosure may include the shelf member 2200 partitioning the accommodation space 2110 of the casing 2100 in the vertical direction (the y-axis direction) and the seating bracket 2300 coupled to the upper surface 2210 of the shelf member 2200 and on which the power module 2010 is seated. In addition, the seating bracket 2300 may include the inclined surface 2310 inclined from one end to the other end, and the power module 2010 may be seated in the inclined state on the inclined surface 2310.

In this regard, the seating bracket 2300 may be formed such that the inclined surface 2310 and the upper surface 2210 of the shelf member 2200 form the step. In addition, the upper surface 2210 of the shelf member 2200 may be coated. Accordingly, the flow channel through which the moisture caused by the dew condensation of the power module 2010 flows may be formed.

Referring to FIG. 8, in the charging device 1000 according to an embodiment of the present disclosure, an inclined angle θ1 of the inclined surface 2310 of the seating bracket 2300 may be, for example, 3 degrees such that the moisture caused by the dew condensation of the power module 2010 may flow while not interfering with the operation of the power module 2010. In this case, the power module 2010 seated on the inclined surface 2310 of the seating bracket 2300 may also be inclined at an angle of 3 degrees.

In the state in which the power module 2010 is inclined, the moisture caused by the dew condensation of the power module 2010 may not accumulate inside the power module 2010 and may fall to the coated upper surface 2210 of the shelf member 2200. In addition, in some cases, the moisture dropped to the upper surface 2210 of the shelf member 2200 may be introduced into the filter member 2500 positioned to face the shelf member 2200.

In this case, to allow the moisture to be introduced into the filter member 2500, the filter member 2500 may be disposed in the vertical direction (the y-axis direction), and a lower surface thereof may be located downward of a lower surface of the shelf member 2200. Accordingly, the moisture caused by the dew condensation of the power module 2010 may be removed.

In addition, an angle θ2 at which the fixing surface 2410 of the fixing bracket 2400 illustrated in FIG. 8 is inclined may also be 3 degrees. This is because, as described above, the role of the fixing bracket 2400 is to allow the operator to easily seat the power cabinet 2000 on the seating bracket 2300. The angle θ2 at which the fixing surface 2410 of the fixing bracket 2400 is inclined may be the same as the angle θ1 at which the inclined surface 2310 of the seating bracket 2300 is inclined.

Referring to FIG. 9, the charging device 1000 according to an embodiment of the present disclosure may include the blower 2600 disposed in the accommodation space 2110 to face the other end of the inclined surface 2310 and the power module 2010. Further, the blower 2600 may be coupled to the rear door 2130 described above. In this regard, the rear door 2130 may include a plurality of second opening holes 2131 defined at locations corresponding to the blower 2600.

In addition, in the charging device 1000 according to an embodiment of the present disclosure, the blower 2600 may be formed to exhaust air toward the power module 2010 or to inhale air from the power module 2010.

Additionally, the blower 2600 may be coupled to a second moisture inflow prevention member 2610. The second moisture inflow prevention member 2610 may serve to block the moisture that may be introduced from the outside via the plurality of second opening holes 2131.

Accordingly, corresponding to the shape of the first moisture inflow prevention member 2510 described above with reference to FIGS. 5 and 6, the second moisture inflow prevention member 2610 may be in a form of an assembly of multiple plates that forms an inclination in the downward direction (the y-axis direction) to block the moisture that may be introduced from the outside.

More specifically, referring to FIG. 10 together, in the charging device 1000 according to an embodiment of the present disclosure, the blower 2600 may be formed to inhale air from the power module 2010. The moisture caused by the dew condensation of the power module 2010 may not stay inside the power module 2010 via the inhaling of air using the blower 2600.

Referring to FIG. 11 together, in the charging device 1000 according to an embodiment of the present disclosure, the blower 2600 may be formed to exhaust air toward the power module 2010. Via the exhaust of air using the blower 2600, the moisture caused by the dew condensation of the power module 2010 may not stay inside the power module 2010.

Accordingly, the power module 2010 may be seated in the inclined state on the inclined surface 2310 of the seating bracket 2300, so that the moisture caused by the dew condensation of the power module 2010 may be rapidly discharged from the inside of the power module 2010 via the exhaust of air using the blower 2600. In addition, the moisture discharged from the inside of the power module 2010 may be introduced into the filter member 2500 via the exhaust of air using the blower 2600, so that the moisture caused by the dew condensation of the power module 2010 may be stably removed.

In addition, to allow the moisture discharged from the inside of the power module 2010 to be introduced into the filter member 2500 via the exhaust of air using the blower 2600, as described above, the filter member 2500 may be disposed in the vertical direction (the y-axis direction) and the lower surface thereof may be located downward of the lower surface of the shelf member 2200.

In this regard, in the charging device 1000 according to an embodiment of the present disclosure, the case in which, in the charging device 1000 according to an embodiment of the present disclosure, one end of the inclined surface 2310 of the seating bracket 2300 located at the front side has the lower vertical level and the other end of the inclined surface 2310 located at the rear side has the higher vertical level is illustrated, but the present disclosure is not limited thereto.

That is, in the charging device 1000 according to an embodiment of the present disclosure, the seating bracket 2300 may be applied even assuming one end of the inclined surface 2310 located at the front side has the higher vertical level and the other end of the inclined surface 2310 located at the rear side has the lower vertical level.

In this case, unlike as shown in FIGS. 7, 10, and 11, the filter member 2500 may be coupled to the rear door 2130, and the blower 2600 may be coupled to the front door 2120. In addition, a principle of removing the moisture caused by the dew condensation of the power module 2010 is the same as that described above.

In addition, referring to FIGS. 10 and 11 together, to efficiently exhaust and inhale air via the blower 2600 in the charging device 1000 according to an embodiment of the present disclosure, as described above, the casing 2100 may include the plurality of first opening holes 2121 defined at the locations corresponding to the filter member 2500 and the plurality of second opening holes 2131 defined at the locations corresponding to the blower 2600. In addition, this may allow the exhaust and the inhaling of air via the blower 2600 to maintain a straight flow.

Therefore, the charging device 1000 according to an embodiment of the present disclosure has an effect of efficiently reducing the heat generation resulted from the operation of the power module 2010 via the plurality of first opening holes 2121 and the plurality of second opening holes 2131 defined in the casing 2100 and the blower 2600 disposed in the accommodation space 2110.

Furthermore, referring to FIG. 12, in the charging device 1000 according to an embodiment of the present disclosure, a printed circuit board 2700 having electronic components mounted on a front surface thereof may be disposed inside the shelf member 2200. In this regard, the printed circuit board 2700 may include a PSU substrate electrically connected to a power supply unit (PSU).

In this regard, the shelf member 2200 may include the coupling surface 2220 formed therein and coupled to a rear surface of the printed circuit board 2700 such that the front surface of the printed circuit board 2700 faces downward. That is, in the power cabinet 2000 according to an embodiment of the present disclosure, via the structure in which the rear surface of the printed circuit board 2700 is coupled to the coupling surface 2220 formed inside the shelf member 2200, the printed circuit board 2700 may be prevented from being damaged by permeation of the moisture caused by the dew condensation of the power module 2010.

Furthermore, in the charging device 1000 according to an embodiment of the present disclosure, the coupling surface 2220 formed inside the shelf member 2200 may be formed to be inclined from one end to the other end corresponding to the inclined surface 2310 of the seating bracket 2300.

As described above with reference to FIG. 8, in the charging device 1000 according to an embodiment of the present disclosure, the inclined angle θ1 of the inclined surface 2310 of the seating bracket 2300 may be, for example, 3 degrees such that the moisture caused by the dew condensation of the power module 2010 may flow while not interfering with the operation of the power module 2010.

Likewise, the coupling surface 2220 formed inside the shelf member 2200 may be inclined at an inclined angle θ3 of 3 degrees so as to be protected from the moisture caused by the dew condensation of the power module 2010 while not interfering with the operation of the printed circuit board 2700.

In addition, in the charging device 1000 according to an embodiment of the present disclosure, the printed circuit board 2700 may be coupled to the coupling surface 2220 formed inside the shelf member 2200 as the rear surface thereof is coated so as to be protected from the moisture caused by the dew condensation of the power module 2010. Accordingly, the printed circuit board 2700 may be protected from the moisture that may flow along the coupling surface 2220 from the upper surface 2210 of the shelf member 2200.

Referring again to FIGS. 2 and 7, the charging device 1000 according to an embodiment of the present disclosure may include an inner plate 2800 disposed to be upright on the lower surface of the shelf member 2200 and partitioning the accommodation space 2110 in the front and rear direction (the z-axis direction). Further, the input module 2020 may be disposed on a front surface of the inner plate 2800, and the output module 2030 may be disposed on a rear surface of the inner plate 2800. This is to more efficiently utilize the accommodation space 2110 of the casing 2100 in which the multiple electronic components are mounted as described above.

In addition, the charging device 1000 according to an embodiment of the present disclosure may secure an advantageous structure for placing the output module 2030 serving to supply and distribute the power to the dispenser 1100 by partitioning the accommodation space 2110 via the inner plate 2800. In addition, by connecting the plurality of power cables 1200 to the output module 2030, as described above with reference to FIG. 1, the power may be supplied and distributed to the at least one dispenser 1100, thereby increasing charging efficiency of the electric vehicle.

In addition, the charging device 1000 of the present disclosure may be the power cabinet 2000 as described above, or may be the dispenser 1100. That is, the charging device 1000 according to the present disclosure may be applied to both the power cabinet 2000 and the dispenser 1100, and may improve electrical stability by removing the moisture caused by the dew condensation of the internal components.

Furthermore, the charging device 1000 of the present disclosure may also be applied to the integrated charging facility in which the dispenser 1100 and the power cabinet 2000 are integrally formed to constitute the single body to charge the electric vehicle, as described above.

That is, a component corresponding to the above-described seating bracket 2300 may be disposed in the main body of the integrated charging facility, the above-described power module 2010 may be seated in the inclined state, and the moisture caused by the dew condensation of the power module 2010 may be removed, thereby improving the electrical stability.

In summary, the charging device according to the present disclosure may improve the electrical stability by removing the moisture caused by the dew condensation of the power module. In addition, the heat generated by the operation of the power module may be efficiently reduced via arrangement of the opening hole defined in the casing and the blower. In addition, the multiple electronic components may be efficiently disposed via the shelf member and the inner plate that partition the accommodation space.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A charging device comprising:
a casing comprising:
a space where a power module is mounted, and
an accommodation space where an input module and an output module electrically connected to the power module are located;
a shelf partitioning the accommodation space of the casing in a vertical direction; and
a seating bracket coupled to an upper surface of the shelf, wherein the power module is seated on the seating bracket,
wherein the seating bracket includes an inclined surface inclined from one end to an opposite end thereof,
wherein the power module is seated in an inclined state on the inclined surface.

2. The charging device of claim 1, wherein the seating bracket has the inclined surface forming a step with the upper surface of the shelf.

3. The charging device of claim 1, further comprising a filter disposed in the accommodation space to face the one end of the inclined surface, the power module, and the shelf.

4. The charging device of claim 3, wherein the filter is disposed in the vertical direction and has a lower surface located downward of a lower surface of the shelf.

5. The charging device of claim 4, further comprising a blower disposed in the accommodation space to face the opposite end of the inclined surface and the power module.

6. The charging device of claim 5, wherein the blower is formed to exhaust air toward the power module or to inhale air from the power module.

7. The charging device of claim 6, wherein the casing includes:
a plurality of first opening holes defined at locations corresponding to the filter; and
a plurality of second opening holes defined at locations corresponding to the blower.

8. The charging device of claim 1, wherein the power module includes a plurality of power modules seated upright on the inclined surface.

9. The charging device of claim 8, wherein the inclined surface includes a plurality of seating ribs formed to be spaced apart from each other and extending from the one end to the opposite end.

10. The charging device of claim 8, further comprising a fixing bracket disposed in the accommodation space and fixing the plurality of power modules seated on the seating bracket.

11. The charging device of claim 10, wherein the fixing bracket has a fixing surface inclined from one end to an opposite end corresponding to the inclined surface.

12. The charging device of claim 1, wherein the upper surface of the shelf is coated.

13. The charging device of claim 1, further comprising a printed circuit board disposed inside the shelf and having electronic components mounted on a front surface thereof,
wherein the shelf includes a coupling surface formed therein and coupled to a rear surface of the printed circuit board such that a front surface of the printed circuit board faces downward.

14. The charging device of claim 13, wherein the coupling surface is inclined from one end to the other end corresponding to the inclined surface.

15. The charging device of claim 13, wherein the rear surface of the printed circuit board is coated and coupled to the coupling surface.

16. The charging device of claim 1, wherein the casing is formed in a shape with open front and rear sides,
wherein the inclined surface is inclined in a rearward direction.

17. The charging device of claim 1, further comprising an inner plate disposed to be upright on a lower surface of the shelf and partitioning the accommodation space in a front and rear direction.

18. The charging device of claim 17, wherein the input module is disposed on a front surface of the inner plate, and the output module is disposed on a rear surface of the inner plate.

19. The charging device of claim 1, further comprising a dispenser configured to receive power converted via the power module and perform charging.

20. The charging device of claim 19, wherein the dispenser includes a plurality of dispensers configured to receive the power via a plurality of power cables connected to the output module.
